(19) United States
(12) Patent Application Publication
(10) Pub. No.: US 2017/0013107 A1
(43) Pub. Date: Jan. 12, 2017

(54) Sky zero

(71) Applicant: Rodney J. Adams, Glendale, AZ (US)

(72) Inventor: Rodney J. Adams, Glendale, AZ (US)

(21) Appl. No.: 14/998,916

(22) Filed: Mar. 4, 2016

Related U.S. Application Data
(60) Provisional application No. 62/189,682, filed on Jul. 7, 2015.

(51) Int. Cl. H04M 1/725; A45F 5/00

(52) U.S. Cl. CPC H04M 1/72522; A45F 5/00; H04B 1/385

(57) ABSTRACT

SKYZERO is elegant, innovative and simple to use. Experience style and design through the finest materials and craftsmanship in a SKYZERO. Design, collect and share ideas from your daily life with the updated and more advanced phone of the future. SKYZERO fits your active lifestyle with additional integrated features and accessories. Satellite is everywhere, and today, your SKYZERO connects to every single satellite tower.

### CROSS REFERENCE TO RELATED APPLICATION

This application claims the benefit of U.S. Provision Application No. 62/189,682 Filed on Jul. 7, 2015, entitled “Rodney Jason Adams”

### BACKGROUND OF THE INVENTION

### Field of the Invention

SKYZERO is designed to give consumers with a mind-blowing new portable device that provides a great many features in addition to those available on conventional cell phones. SKYZERO can be used for receiving calls, searching the internet, sending and receiving text messaging, email, and providing directions from one locator to the next. Just like other cell phones on the market. SKYZERO is linked to worldwide satellite so the user will never experience dropped calls or dead zones when they are far from a cell phone tower. SKYZERO is protected by DNA, Voice, and Fingerprint Recognition Systems so it cannot be used by an unauthorized person if it is stolen. The theft sensor will shut down all functions on the phone when unauthorized person attempts to use phone. SKYZERO responds to voice commands so messages will be translated into text messages and sent to other without having to enter a message on the keyboard manually eliminating the distraction of texting while driving. When the phone rings it lights up in several different colors.

A safety alarm on the phone will protect users if they are being assaulted. It responds to a voice command and will take pictures of the attacker or situation. Also, the SKTZERO will issue an alarm so loud that it can be heard a mile away. Attacker will want to run away when they here this alarm. The safety sensor also prevents the user from texting while driving. The safety sensor have a GPS mode build in so when you are driving it will not allow you to text. This feature will help save life's and present motor vehicle accidents. The SKYZERO smoke alarm will work the same way as any other smoke alarm. The difference with the SKYZERO smoke alarm is that it works on voice command, its taking photos, sounding a loud alarm, and summoning assistance all at the same time. SKYZERO has its own internal climate control sensor. So it will never shut off by being too warm or cold. SKYZERO has eight cameras. Two cameras on the front, two cameras on the back, and two cameras on each side which can all work at the same time capturing the scene from different angles. SKYZERO has the capability to take pictures in all directions at the same time, and provide additional security for the owner of the phone.

SKYZERO can be used by someone on the moon. On the moon SKYZERO have the capability to take pictures and transmit them to earth. SKYZERO also has the capability of editing pictures were a person can insert themselves in a photo that they were not present for. SKYZERO can attach to the user's wrist like a watch with a strap. This prevents dropped lost, or stolen. When you go hiking, running, working out, or swimming are just doing anything and don't want to lay it down. SKYZERO is made of unbreakable glass, waterproof, and has a kickstand on the back so it can be propped up on a desk or table. Because SKYZERO is connected to a worldwide satellite system. It provides the user with the fastest interne speed possible without having to pay reaming charges. SKYZERO has a credit senor and hacker protection so the user's privacy is never jeopardized. When someone is checking on the user's credit, the owner will be notified and the identity and location will be revealed. If the owner receives at least three calls from a blocked number, and feel they are being harassed by the caller the number will be unblocked. The identity and location of the caller using a blocked number repeatedly will be revealed to the recipient of those calls.

SKYZERO additional functionality includes facial recognition, ability to translate messages in any language, and a small digital projector. Picture videos, and text can be projected unto a wall. For sharing with others, pictures can be taken, edited, and sent to other or posted on social media using this device. SKYZERO also has a build in voice recognized senor in the phone. It will always recognize a person voice with the name once they call your phone so you never have to worry about a person calling you and harassing you over the phone. SKYZERO also is fireproof and won't catch fire cause of the climate control senor. Has LD, high, medium, and low lighting. Lighting can also be controlled by voice command. SKYZERO have a Halo gram text message and picture system. You can have Halo gram text or photo of yourself and send it to whomever you want to send it to. SKYZERO has built in cable senor that allows you to watch all cable channels and order pay per view right from your phone. SKYZERO has built in auto tune senor that allows you to sing like a pro, sound like a star, and make music right from your phone.

SKYZERO has safety mode sensor and push panic button with the four GPS. That safety mode sensor allows you to push the panic button or in a real dangerous situation use voice command to say call the police. If you can't talk the panic button will save your life. All you have to do is push the button and wait for the police to arrive. With the Four GPS tracker installed in your phone the police can track your location faster. SKYZERO is able to be use underground and outer space. SKYZERO has an voice command that light up to any color you want your screen to be. Phone can stay charge all day and night without having to plug it in. There is no battery needed. The phone charges by sun, electric, and satellite. SKYZERO has super slow motion, fast motion picture, recording on land or in water. It also has info red picture and recording for safety. It can show it at time of taking picture or recording. You can also go back for review. SKYZERO can be installed in cars, trucks, buses, planes, jets, trains, home television, computers, police vehicles, fire tracks, businesses, homes, street lights, cameras, airports, and schools. SKYZERO is here to make the world a safer place for all life'.

### SUMMARY OF THE INVENTION

I view of the unique of the product will provide the following benefits for the consumer worldwide.

It is a stylish new cell phone that provides users with all the latest features expected on a cellphone plus a whole lot more.

All functions can be voice-controlled so the user will not be distracted by looking at the screen or keyboard while driving function will be unavailable while driving. It has motion sensor that will stop all the texting availability if it going over ten miles per hour in the car.

Pictures of criminals in action can be captured and send immediately to law enforcement authorities so many more criminals will be apprehended and removed from the street your voice-control will let you control your cameras and take pictures without having to touch your phone for anything

### BRIEF DESCRIPTIONS OF THE DRAWINGS

Although the characteristics of the features of this invention will be particularly point out in the claims the invention itself stands out in which it may be better understood after a review of all description, taken in connection with the drawing where in which are provide throughout.

FIG. 1 shows a front view of the cell phone in its design great look that provide all 4 features in different angles.

FIG. 2 show a side view of the cell phone with show the side design in eight different views.

FIG. 3 show a back view of the cell phone in its design look with strap and six views or what it offers.

FIG. 4 shows a front view of the cell phone with its design with its other features of five views and back and kickstand.

FIG. 5 show a back view of the cell phone with it full design look, with is wrist strap.

### DETAILED DESCRIPTION OF THE INVENTION

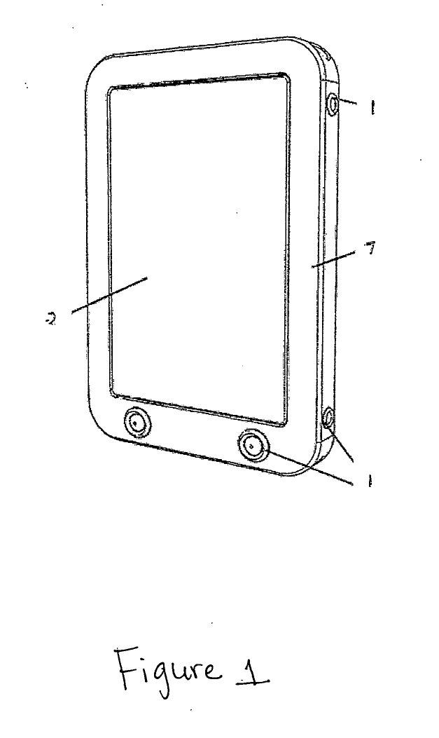

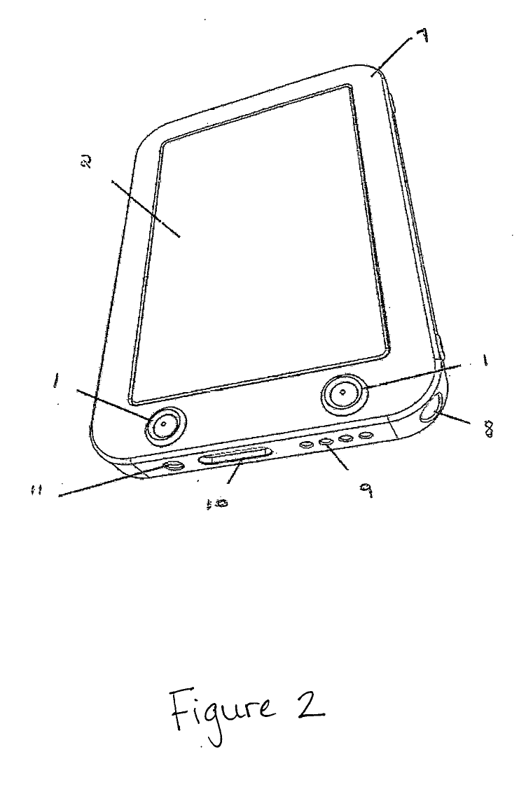

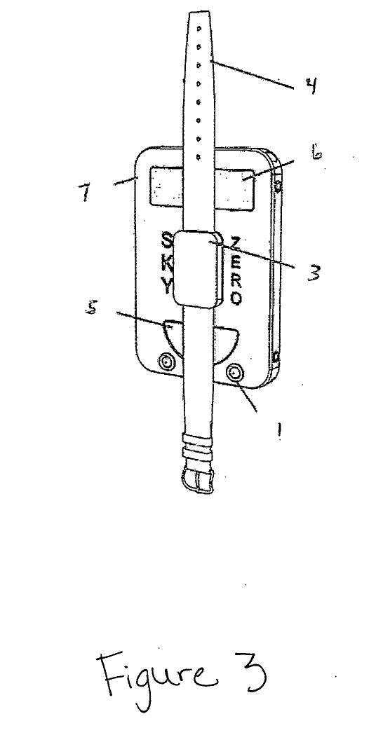

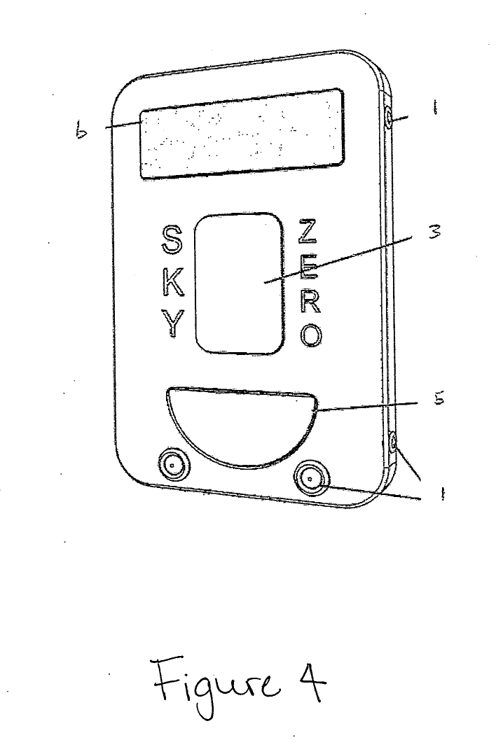

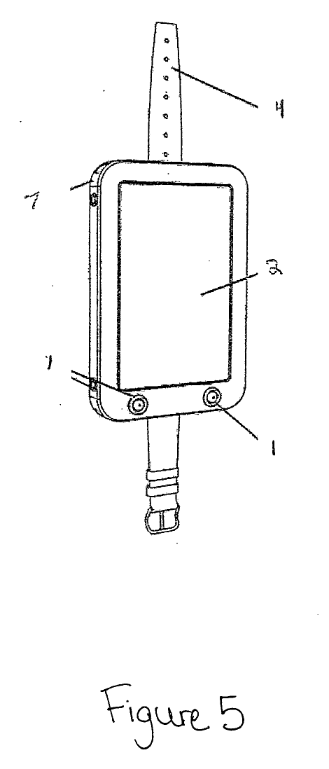

Sky zero is design to give consumer with a mind-blowing new portable device that provides a great many new features, to addition to those available on conventional cell phones. It can be used to placing and texting phone calls searching the internet sending a receiving text message and e-mails and provide direction from one location to the next just like other cell phones currently on the market. It is linked to a worldwide satellite so the user will never experience dropped calls or dead-zones when they are far from the cell tower. Its protected by DNA voice and fingerprint recognition systems, so it cannot be use by an unauthorized person if it is lost or stolen. The theft sensor will shut down all functions on the cell phone when a unauthorized person attempts to use the cell phone. It respond to voice command on all features of the phone even camera. It also messages will be translated in to text message and send to other without having to enter a message on a keyboard manually, that will eliminate the distraction while driving and with a built in motion sensor it will not let you to text message while driving and any moving vehicle, the motion sensor will be activated ones your vehicle starts moving ten miles per hour. [FIG. 1] Referring now to FIG. 1[14] There it shows a front view of sky zero in its devices of the present invention it shows two camera on the front of the cell phone with it design to have HD picture taking and is operated by voice-command and motion with aloud you to operate your cell phone to start taking pictures with your voice-command telling it what to do to show the display. Touch screen of how its design with unbreakable glass a water proof with is operated by manually and voice-command 7 shows the phone how thin a sexy the style of the cell phone looks. 8 show the GPS which has 4 GPS on each of the corner of the cell phone with will keep you safe and can be found it ever in a lost and harm way. 9 show a speaker of 4 which gives you great connection and sounds with auto-tune build in you can make great sounds and connections to friends and family. 10 shows USB for installing in to anything that will take USB port and it saves all your information for safe keeping and is hacker proof. 11 show a head phone jack for listening to music on the phone. [FIG. 2] Referring now to FIG. 2 There it show the side view of Sky Zero with a nice design of thin sexy look 1 shows 3 cameras on the cell phone one on the top of the side, and one on the bottom side and one on the front side with HD view for great looking picture with is operated manual and by voice-command-motion to have your camera to take pictures with your voice-command saying take picture without you having to find camera mode saves time. 2 shows display touch screen with great side look 7 show side view of the cell phone off low great and thin it is and it is unbreakable cell phone. [FIG. 3] Referring now to FIG. 3. There it shows a back view of Sky Zero with a great new design look which has HD lighting and info red and 3 shows a base board strap that allows you to wear it as a watch, and it has blood pressure and pulse monitoring to keep you safe while walking or hiking. 5 shows a kickstand to pop up to view videos and social media view together with friends. 6 shows a solar panel to keep your cell phone charge at all times with worldwide satellite usage and lighting 7 shows view of sexy thin cell phone which has too many features to keep you safe and have fun with Sky Zero. [FIG. 4] Referring now to FIG. 4. There it shows the back side of Sky Zero with a design that never has been seeing. 1 shows cameras on the right side on the top and the bottom of the cell phone and 3 shows the base board wear the strap attached too. 5 shows kick stand, and 6 shows solar panel. All operated by manual and voice-command, Sky Zero has so many features it shows all in I claim. [FIG. 5] Referring now to FIG. 5. There it shows the front view of Sky Zero with a great look at the cell phone. 1 shows 3 camera view two in the front and one on the left side of the cell phone, all cameras has many features to record and view and take pictures 2 shows the front of the sexy cellphones 4 shows the strap and 7 shows left side of cell phone Sky Zero has to many features to operate the cell phone be mind blowing by the design and many features Sky Zero has to offer.

I claim:

1. Sky Zero has the design to do so much more than the cell phones out there in the world today, Sky Zero has so many new features available, voice-command-motion, for calling, texting, e-mailing which has worldwide satellite usage, DNA voice and fingerprint recon nation system, theft sensor, voice translation, text message,-email-in all language translation, safety alarm, safety sensor, smoke alarm, 8 cameras, a phone that can be use on the moon with world-wide satellite usage, attachable wrist strap, unbreakable glass and phone water proof and fire proof; credit sensor, hacker protection, face recognization, id sensor, digital projector, voice recongnizator sensor, climate control sensor, HD lighting, high-medium-low, halogram texting and picture, cable sensor with pay preview reviewing, auto tune sensor, safety motive sensor, panic button sensor, 4 GPS solar panel to keep phone charge with solar-, light, electric, info red, motion sensor, metal detector sensor-, baby sensor, underground GPS sensor, all this can be installed, cars, trucks, house, planes, jets, trains. Home tv's computers, police cars, fire trucks, business, bank atm, street lights, all cameras, airports, schools, air forces, Sky Zero offers which can be installed in to almost everything and child protector monitor system.

2. The device of claim 1, wherein said to provide new feature to make a new improve cell phone that will make consumers enjoy life and be safe.

3. The device of claim 1, wherein said Sky Zero has the feature to make safe and with so many features that will change the word.

4. The device of claim 1 wherein said that all new features is here to chance the way the world be operated all features are great features.
